(19) United States
(12) Patent Application Publication
(10) Pub. No.: US 2010/0038326 A1
(43) Pub. Date: Feb. 18, 2010

(54) FILTERING MEDIUM COMPRISING GRAFTED LEWIS BASE MOLECULES

(75) Inventor: Nabila Kourda, Peronne (FR)

Correspondence Address: BACHMAN & LAPOINTE, P.C., 900 CHAPEL STREET, SUITE 1201, NEW HAVEN, CT, 06510, US

(73) Assignee: LAINIERE DE PICARDIE BC, Peronne (FR)

(21) Appl. No.: 12/522,589

(22) PCT Filed: Jan. 28, 2008
(86) PCT No.: PCT/FR2008/000097

§ 371 Date: Aug. 25, 2009

(30) Foreign Application Priority Data
Jan. 29, 2007 (FR) 0700591

(51) Int. Cl. B01D 61/00; B01D 39/08; C08J 7/04

(52) U.S. Cl. 210/767; 210/507; 427/501

(57) ABSTRACT

A medium for the filtration of a fluid containing molecules of a Lewis acid is described, wherein the medium comprises a fluid-porous textile substrate having molecules grafted thereto, the molecules including at least one group having the properties of a Lewis base, such that the molecules of the above-mentioned Lewis acid can be retained in the textile substrate upon complexation with the grafted groups. A method for producing one such medium and a method for removing boric acid from an aqueous solution using one such filtration medium are described.

### BACKGROUND

(1) Field of the Invention

The invention relates to a filtering medium of a fluid containing Lewis acid molecules, a method for producing such a medium and a method for removing boric acid from an aqueous solution by means of such a filtering medium.

The invention particularly applies to the field of water purification by making it possible to remove boric acid which is present in solution. For example, boric acid is present in small quantities in seawater and, for health reasons, it is necessary to remove acid during the desalination process with a view to rendering said water fit for consumption.

(2) Prior Art

For this purpose, the following two types of techniques are essentially known:

by complexing boric acid on activated carbon or ion exchange resins by increasing the pH of the solution to be treated in order to create H₂BO₃⁻ charged species. In addition, due to the cost thereof, the complexing agents are regenerated which complicates the process;

by means of reverse osmosis wherein the performances are significantly dependent on the ionic composition of the water.

### SUMMARY OF THE INVENTION

The aim of the invention is to address the limitations of the prior art by proposing, in particular, a filtering medium which makes it possible to remove a Lewis acid in a fluid without requiring a specific prior treatment of said fluid, particularly without acid and/or basic reagent compounds. In addition, due to the easy manufacture and low cost thereof, the filtering medium may be of the disposable type after use.

To this end, according to a first aspect, the invention proposes a filtering medium of a fluid containing Lewis acid molecules, said medium comprising a textile substrate which is porous to the fluid whereon molecules comprising at least one group having the properties of a Lewis base are grafted, so as to enable the retention of the molecules of said Lewis acid in the textile substrate by means of complexing with the grafted groups.

According to one embodiment, the grafting of the Lewis base molecules is performed by means of coupling with surfactant molecules, the Lewis base molecules also comprising at least one reactive group in ionising radiation and the surfactant molecules comprising at least two types of reactive groups in ionising radiation.

According to a second aspect, the invention proposes a method for producing such a filtering medium, said method envisaging:

impregnating the substrate with a Lewis base molecule solution, said solution also comprising surfactant molecules which are capable of improving the wettability of the textile substrate by said solution,

applying ionising radiation on the impregnated textile substrate to, by means of a reaction of the reactive groups, ensure the grafting of the Lewis base molecules by means of coupling with the surfactant molecules.

According to a third aspect, the invention proposes a method for removing boric acid from an aqueous solution, said method envisaging passing said solution through a filtering medium, so as to enable the retention of the boric acid in said medium by complexing said acid with the grafted Lewis base groups.

Other specificities and advantages of the invention will emerge in the description hereinafter of various specific embodiments.

### DETAILED DESCRIPTION OF THE PREFERRED EMBODIMENT(S)

The invention relates to a filtering medium of a fluid containing Lewis acid molecules, particularly an aqueous solution containing boric acid, in particular.

In one example of an embodiment, the fluid is seawater which typically comprises of the order of 5 mg/l of boric acid. The filtering medium is arranged to enable the removal of said boric acid so as, in combination with a known desalination treatment, to render said water fit for human consumption. According to European and French legislation, the maximum quantity of boron in a water intended for human consumption is 1 mg/l. Therefore, within the scope of the invention, the removal of boric acid by means of filtration refers to a quantity of boron present in the filtrate which is at most equal to this value, particularly less than 0.1 ppm.

The filtering medium comprises a textile substrate which is porous to the fluid so as to enable the passage of said fluid therethrough during filtration. According to one embodiment, the textile substrate is based on fibres made of polyolefinic material, particularly polypropylene which offers the advantages of good mechanical resistance, chemical inertia and a low cost. For example, the substrate may comprise a non-woven lap. In an alternative embodiment, the textile substrate may be formed from at least one woven or knitted layer.

Furthermore, molecules comprising at least one group displaying Lewis base properties are grafted on the textile substrate. It is noted that a Lewis acid is a molecule liable to accept a pair of electrons having an empty orbital and a Lewis base is an electron pair donor having a free pair.

In particular, the grafted groups may comprise a nitrogen atom and/or an oxygen atom wherein the electron pair is free. According to embodiments, the grafted groups are selected in the group comprising the amine groups, alcohol groups and carbonyl groups.

In this way, by passing the fluid through the textile substrate, it is possible to retain the Lewis acid molecules in said substrate by complexing with the Lewis base groups grafted thereon.

In an alternative embodiment, it is possible to envisage that the textile substrate is based on fibres made of a material having electron pair donor atoms, for example made of cellulose or polyvinyl alcohol comprising the alcohol function. In these cases, the aim of the grafting is to reinforce the Lewis base nature of the textile substrate in order to improve the Lewis acid retention capacity thereof.

Furthermore, it is possible to envisage that the textile substrate is grafted with other functional groups, for example bacteriostatic, virucidal or ion exchange groups, so as to provide a further function to the filtering medium.

According to one embodiment, the Lewis base molecules are grafted by means of coupling with surfactant molecules, which particularly makes it possible to ensure reliable grafting and increase the quantity of grafted groups.

For this purpose, the Lewis base molecules may also comprise at least one reactive group in ionising radiation and the surfactant molecules may comprise at least two types of reactive groups in ionising radiation, said groups possibly being identical or different from each other.

The reactive groups may comprise an unsaturated bond which, under the effect of ionising radiation, forms a reactive free radical. In particular, the reactive groups in ionising radiation are selected in the group comprising hydroxyl, carboxyl, carbonyl, acrylate, methacrylate, allyl, amine, amide, imide, urethane groups.

In examples of embodiments, the Lewis base molecule is a dialkylaminoalkyl methacrylate (particularly dimethylaminoethyl methacrylate) or an alkyl trialkyl ammonium methacrylate (particularly acryloxyethyltrimethyl ammonium). The surfactant molecule is selected in the group comprising diacrylates, particularly polyethylene glycol diacrylates (PEG DA), and triacrylates, particularly ethoxylated trimethylpropane triacrylates. In particular, with polypropylene fibres, ethoxylated trimethylolpropane triacrylate 20 is particularly suitable.

A method for producing a filtering medium using molecules according to these examples of embodiments is described below.

The method envisages impregnating the textile substrate with a Lewis base molecule solution. According to the solubility of the molecules, the solution may at least partially come in the form of an emulsion.

According to one embodiment, the impregnation is performed by means of padding, the impregnated textile substrate being dried before the application of ionising radiation.

The solution may comprise other agents, particularly for improving the solubility of the molecules and/or the stability of said solution. In addition, if other functional groups need to be grafted on the textile substrate, the solution also comprises the corresponding molecules.

The method envisages, to improve the wettability of the textile substrate by the solution, that said solution also comprises a surfactant molecule. In this way, by improving the affinity between the solution and the fibres of the textile substrate, the method makes it possible to graft textile substrates even if they are based on synthetic fibres displaying a high hydrophobicity.

In particular, the nature and quantity of the surfactant molecules in the solution are envisaged so that the surface tension of the solution is similar to that of the fibres. In this way, the textile substrate may be impregnated with a large volume of solution, so as to increase the density of Lewis base groups which are grafted on the textile substrate.

Then, by applying ionising radiation on the impregnated textile substrate, the reaction of the reactive groups ensures the grafting of the Lewis base molecules by means of coupling with the surfactant molecules. Indeed, the reactions of the reactive groups make it possible to bind the surfactant molecules with the fibres or with each other, and the Lewis base molecules with the surfactant molecules or directly with the fibres. This creates a network between the fibres and the molecules which is particularly resistant with respect to chemical and mechanical stress to which the filtering medium will be subjected within the scope of the use thereof.

According to one embodiment, the ionising radiation consists of electron bombardment wherein the power and duration may be modulated to activate the reactive groups optimally.

Furthermore, the grafting method is particularly modular in that the nature of the surfactant molecule may be selected according to the textile substrate, particularly according to the surface tension thereof.

After applying the ionising radiation, the textile substrate may be washed and dried or undergo other treatments necessary for the subsequent use thereof. In addition, before grafting, the textile substrate may undergo specific treatments, particularly to improve the cohesion and/or wettability and/or porosity thereof.

The use of a textile substrate according to the invention makes it possible to implement a method for removing boric acid from an aqueous solution. The method envisages passing said solution via the filtering medium so as to enable the retention of boric acid in the medium by complexing said acid with the grafted Lewis base groups.

In particular, it is possible to adjust the thickness of the textile substrate to obtain the desired boron concentration in the filtrate. In addition or in an alternative embodiment, it is also possible to stack several filtering media to increase the quantity of boric acid retained.

1-12. (canceled)

13. A filtering medium for a fluid containing Lewis acid molecules, said filtering medium comprising a textile substrate which is porous to the fluid whereon molecules comprising at least one group having the properties of a Lewis base are grafted so as to enable retention of the molecules of said Lewis acid in the textile substrate by complexing with the at least one grafted groups.

14. The filtering medium according to claim 13, wherein the textile substrate is based on fibres made of polyolefinic material.

15. The filtering medium according to claim 13, wherein the at least one grafted group comprises at least one of a nitrogen atom and an oxygen atom wherein the electron pair is free.

16. The filtering medium according to claim 15, wherein the at least one grafted group is selected from the group consisting of the amine groups, alcohol groups and carbonyl groups.

17. The filtering medium according to claim 13, wherein the grafting of the Lewis base molecules is performed by means of coupling with surfactant molecules.

18. The filtering medium according to claim 17, wherein the Lewis base molecules comprise at least one reactive group in ionising radiation, and the surfactant molecules comprises at least two types of reactive groups in ionising radiation.

19. The filtering medium according to claim 18, wherein the reactive groups in ionising radiation are selected from the group consisting of hydroxyl, carboxyl, carbonyl, acrylate, methacrylate, allyl, amine, amide, imide, and urethane groups.

20. The filtering medium according to claim 19, wherein the Lewis base molecule is a dialkylaminoalkyl methacrylate or an alkyl trialkyl ammonium methacrylate, and the surfactant molecule is selected from the group consisting of diacrylates, polyethylene glycol diacrylates (PEG DA), triacrylates, and ethoxylated trimethylpropane triacrylates.

21. A method for producing a filtering medium according to claim 18, said method comprising the steps of:
impregnating the textile substrate with a Lewis base molecule solution having surfactant molecules which are capable of improving the wettability of the textile substrate by said solution, and
applying ionising radiation to the impregnated textile substrate to graft the Lewis base molecules by means of coupling with the surfactant molecules and by means of a reaction of the reactive groups.

22. The method according to claim 21, wherein the impregnating step is performed by means of padding, and the impregnated textile substrate is dried before the application of ionising radiation.

23. The method according to claim 21, wherein the ionising radiation applying step comprises applying the ionising radiation by electron bombardment.

24. A method for removing boric acid from an aqueous solution, said method comprising passing said solution through a filtering medium according to claim 18, so as to enable retention of boric acid in the filtering medium by complexing said boric acid with the grafted Lewis base groups.
